(19) United States
(12) Patent Application Publication
(10) Pub. No.: US 2023/0148618 A1
(43) Pub. Date: May 18, 2023

(54) FERMENTED MILK COMPOSITIONS FOR USE IN METHODS OF NUTRITIONAL SUPPLEMENTATION

(71) Applicant: Compagnie Gervais Danone, Paris (FR)

(72) Inventor: Hana KOUTNIKOVA, Gif sur Yvette (FR)

(21) Appl. No.: 17/907,558

(22) PCT Filed: Mar. 29, 2021
(86) PCT No.: PCT/IB2021/000226

§ 371 Date: Sep. 28, 2022

Related U.S. Application Data
(60) Provisional application No. 63/001,835, filed on Mar. 30, 2020.

(51) Int. Cl. A23C 9/123; A23L 33/175; A23L 33/19

(52) U.S. Cl. CPC A23C 9/123; A23L 33/19; A23L 33/175

(57) ABSTRACT

The present invention relates to fermented milk compositions and their use in nutritional supplementation.

### FIELD OF THE INVENTION

The present invention relates to fermented milk compositions and their use in nutritional supplementation.

### TECHNICAL BACKGROUND

Dairy fermented products are long known and widely consumed. They typically comprise milk or milk components (including water), fermented by lactic acid bacteria. Such products are available in various forms, including “yogurts” and “fermented milk products”. Fermented milk products of the yogurt type are obtained by fermentation of milk with a combination of strains of lactic bacteria, typically Streptococcus thermophilus and Lactobacillus bulgaricus. These products are available with various nutritional profiles depending typically on the amount of fat, protein, and carbohydrates, and added sugar, in the composition. Epidemiological studies indicate that yogurt consumption is associated with reduced body weight gain and lower incidence of type 2 diabetes in humans. More recently, it was shown that yogurt intake for 24 weeks improved insulin resistance and liver fat in obese women with nonalcoholic fatty liver disease and metabolic syndrome (Chen et al., Am J Clin Nutr. 2019 Jun 1; 109(6):1611-1619). The mechanism by which yogurt prevents these metabolic disorders is unclear.

The presence of leucine metabolites beta-hydroxy-beta-methylbutyric acid (HMB) and alpha-hydroxyisocaproic acid (HICA) has been disclosed in fermented milk products by Ehling & Reddy (J Agric Food Chem. 2014 Feb 19; 62(7):1506-11). However, the Authors were of the opinion that the levels of HMB & HICA detected in fermented milk products were insufficient to provide dietary benefits and recommended supplementation of the products.

Surprisingly the present Inventors have determined that the hydroxy branched-chain amino acid metabolites (h-BCAAs) present in fermented dairy products also include additional fermentation metabolites resulting in much higher overall levels of h-BCAAs than those observed by Ehling & Reddy and thus providing a promising new means for dietary supplementation.

### SUMMARY OF THE INVENTION

The present invention follows from the unexpected finding that fermented milk compositions can comprise the h-BCAAs HICA, alpha-hydroxyisovaleric acid (HIVA) & 2-hydroxy-3-methylvaleric acid (HMVA) in suitable amounts for nutritional supplementation.

### DETAILED DESCRIPTION OF THE INVENTION

As used herein the term “plant based” or shall be taken to mean a composition or product which does not contain animal or animal derived (e.g. mammal milk) matter.

As used herein the term “dairy” shall be taken to mean a composition or product comprises or consists of mammalian milk matter, i.e. the lacteal secretion obtainable by milking.

As used herein the term “dairy-free” shall be taken to mean a composition or product which does not contain mammalian milk matter, i.e. the lacteal secretion obtainable by milking.

As used herein the term “BCAAs” or “branched chain amino acids” shall be taken to mean Isoleucine, Leucine and Valine.

As used herein the term “x% (w/w)” or “x% w/w” is equivalent to “x g per 100 g”.

In the context of this application, the term “at least” also includes the starting point of the open range. For example, an amount of “at least 95.00 % w/w” means any amount equal to 95.00 percentage by weight or above.

In the context of this application, the term “about” defines a range of plus or minus 10% of the cited value. For example, an amount of “about 20 weight %” means any amount within the range of 18 to 22 weight %.

As used herein the term “nutritional supplementation” or “dietary supplementation” shall be taken to mean increasing the amount of a specified nutrient consumed by an individual as part of their diet and as part of their food intake.

As used herein the term “dietary supplement” shall be taken to mean a product that is intended to be ingested in addition to the normal diet of a subject for nutritional purposes.

As used herein the term “HICA” shall be taken to refer to alpha-hydroxyisocaproic acid.

As used herein the term “HIVA” shall be taken to refer to alpha-hydroxyisovaleric acid.

As used herein the term “HMVA” shall be taken to refer to 2-hydroxy-3-methylvaleric acid.

As used herein the term “h-BCAA” refers to hydroxy branched-chain amino acid metabolites (i.e. branched chain hydroxy acids) and shall be taken to collectively refer to HICA, HIVA and HMVA, along with enantiomers, racemic mixtures, salts, esters or hydrates thereof.

As used herein the terms “h-BCAA concentration” or “concentration of h-BCAA” shall be taken to refer to the sum total of HICA, HIVA and HMVA concentrations.

As used herein the terms “-free” or “free from” shall be taken to mean a composition or product which preferably does not contain a given substance but where trace amounts or contaminants thereof may be present.

As used herein, the term “fermented plant-based” shall be taken to mean a product or composition that is the product of the acidifying fermentation of a plant-based composition by a starter culture of fermenting microorganisms, in particular bacteria, preferably lactic acid bacteria.

### Dietary Supplementation

In a first aspect the present invention provides uses and methods for branched chain amino acid metabolite supplementation of an individual comprising administering to the individual a nutritional composition of the invention. Supplementation according to the compositions and methods of the present invention may provide health benefits. Said uses or methods are preferably non-therapeutic.

Accordingly, in a first embodiment the present invention provides the use of a fermented milk composition for dietary supplementation of branched chain amino acid metabolite. Preferably said branched chain amino acid metabolite are h-BCAAs. Preferably said h-BCAAs are selected from the group consisting of HICA, HIVA, HMVA and combinations thereof. In a most preferred embodiment said h-BCAAs are the combination of HICA, HIVA and HMVA.

In an alternative embodiment the present invention provides a method for dietary supplementation of branched chain amino acid metabolite in a subject comprising administering a fermented milk composition comprising said branched chain amino acid metabolite to a subject in need thereof. In embodiments said branched chain amino acid metabolite are h-BCAAs. In embodiments said h-BCAAs are selected from the group consisting of HICA, HIVA, HMVA and combinations thereof. In a most preferred embodiment said h-BCAAs are the combination of HICA, HIVA and HMVA.

In embodiments of the uses or methods according to the present invention said fermented milk composition is fermented by means of lactic acid bacteria. It is particularly preferred that said lactic acid bacteria comprise one or more species selected from the group consisting of S. thermophilus, L. bulgaricus, Lc. lactis, Lc. cremoris and combinations thereof.

In embodiments the fermented milk composition is not a dietary supplement but is consumed as part of the normal diet of an individual or subject.

In embodiments of the uses or methods according to the present invention said h-BCAAs are a lactic acid bacteria metabolite of dairy milk fermentation.

Surprisingly the Inventors have observed that higher levels of h-BCAAs were present in dairy fermented milks, accordingly in one embodiment the fermented milk composition according to uses and methods of the invention is not dairy-free.

In embodiments of the invention said fermented milks are substantially free from fermented plant-based matter. In further embodiments said fermented milk composition comprises 20%, 15%, 10% w/w or less fermented plant-based matter. In embodiments said fermented plant-based matter is selected from the group consisting of fermented legumes, nuts, seeds, cereals and/or combination thereof.

In embodiments said legumes, are pulse or pulses. In embodiments the pulses are selected from the group consisting of split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy and/or lupin. In preferred embodiments, the pulses are pea and/or chickpea.

In embodiments the nuts are selected from the group consisting of almonds, cashews, pecans, macadamias, hazelnuts, pistachio, walnuts or combinations thereof.

In embodiments the seeds are selected from the group consisting of hemp, pumpkin, quinoa, sesame, tiger nut, flax, chia, sunflower, coconut or combinations thereof.

In embodiments said cereals are selected from the group consisting of wheat, rye, spelt, barley, oat, millet, sorghum, rice, teff and combinations thereof.

Accordingly in embodiments the fermented milk composition is a fermented dairy milk composition that is free from fermented soy, coconut, almond, oat, rice or combinations thereof.

In embodiments of the uses or methods according to the present invention said fermented milk composition comprises at least about 5.00 mg/L, 10.00 mg/L or 12.00 mg/L h-BCAA concentration. In embodiments of the uses or methods according to the present invention said fermented milk composition comprises from 1.00 mg/L to 100 mg/L, from 5.00 mg/L to 100.00 mg/L, from 10.00 mg/L to 85.00 mg/L, from 10.00 mg/L to 75.00 mg/L or from 12.00 mg/L to 75.00 mg/L h-BCAA concentration. These concentrations are considered as providing suitable amounts for nutritional supplementation of a subject.

In embodiments of the uses or methods according to the present invention said fermented milk composition comprises at least about 2.50 mg/L, 3.00 mg/L or 3.50 mg/L HICA. In embodiments of the uses or methods according to the present invention said fermented milk composition comprises from 2.00 mg/L to 50.00 mg/L, from 2.50 mg/L to 35.00 mg/L or from 3.00 mg/L to 35.00 mg/L HICA.

In embodiments of the uses or methods according to the present invention said fermented milk composition comprises at least about 1.00 mg/L, 2.00 mg/L or 3.00 mg/L HIVA. In embodiments of the uses or methods according to the present invention said fermented milk composition comprises from 1.00 mg/L to 50.00 mg/L, from 1.00 mg/L to 40.00 mg/L, from 2.00 mg/L to 40.00 mg/L or from 3.00 mg/L to 40.00 mg/L HIVA.

In embodiments of the uses or methods according to the present invention said fermented milk composition comprises at least about 2.00 mg/L, 2.50 mg/L, 3.00 mg/L or 3.50 mg/L HMVA concentration. In embodiments of the uses or methods according to the present invention said fermented milk composition comprises from 2 mg/L to 10 mg/L, from 2 mg/L to 8 mg/L or from 3 mg/L to 8 mg/L HMVA concentration.

In embodiments of the uses or methods according to the present invention said milk is preferably dairy milk.

### Subject

The “subject” according to the invention is a mammal, preferably a human. The subject according to the invention may suffer from a disease or disorder, however, it is preferred that the individual according to the invention does not suffer from such a disease or disorder. In a particular embodiment of the invention, the individual is considered as being part of the general population or healthy.

In embodiments the subject is in need of musculoskeletal anabolism, reduced dietary intake, reduced insulin secretion, reduced liver triglyceride, improved glucose metabolism.

### Dairy Compositions

Preferably, the fermented milk composition according to the invention is a dairy composition.

Preferably, the fermented milk composition according to the invention comprises or derives (in particular by fermentation) from a composition containing from 30 to 100% (w/w) milk, more preferably from 50 to 100% (w/w) milk and even more preferably from 70 to 100% (w/w) milk.

Preferably also, the dairy composition according to the invention comprises or derives (in particular by fermentation) from a composition essentially consisting of dairy milk or consisting only of dairy milk.

Preferably, the dairy composition according to the invention comprises or derives (in particular by fermentation) from a composition comprising one or both of skimmed or non-skimmed milk. Preferably said milk or milks may be in liquid, powdered and/or concentrated form. In one embodiment said milk or milks may be enriched or fortified with further milk components or other nutrients such as but not limited to vitamins, minerals, trace elements or other micronutrients. Preferably, the dairy composition according to the invention is a fermented dairy composition, more preferably a fermented milk composition such as but not limited to a yogurt or yogurt-type product.

As intended herein, a “fermented dairy composition” is derived from a dairy composition according to the invention by the acidifying action of at least one lactic acid bacterium, which may be comprised in a ferment, inoculant, culture or starter. More preferably said dairy composition according to the invention is obtained by the acidifying action of at least one, two, three, four, five, six, seven or more lactic acid bacteria strains. Accordingly the “fermented dairy composition” comprises at least one, two, three, four, five, six, seven or more lactic acid bacteria strains.

The lactic acid bacterium according to the invention preferably belongs to an Aerococcaceae, Carnobacteriaceae, Enterococcaceae, Lactobacillaceae, Leuconostocaceae, Streptococcaceae or Bifidobacteriaceae family and more preferably to an Aerococcus, Carnobacterium, Enterococcus, Lactobacillus, Lactococcus, Leuconostoc, Oenococcus, Pediococcus, Streptococcus, Tetragenococcus, Vagococcus, Weissella or Bifidobacterium genus. More preferably, the lactic acid bacterium according to the invention belongs to a Lactobacillus brevis, Lactobacillus buchneri, Lactobacillus casei, Lactobacillus curvatus, Lactobacillus delbruckei, in particular L. delbruckei supsb. bulgaricus or lactis, Lactobacillus diolivorans, Lactobacillus fermentum, Lactobacillus fructivorans, Lactobacillus helveticus, Lactobacillus hilgardii, Lactobacillus jensenii, Lactobacillus kunkeei, Lactobacillus mali, Lactobacillus nagelii, Lactobacillus paracasei, in particular:

L. paracasei subsp. paracasei, Lactobacillus plantarum, Lactobacillus vini, Lactobacillus rhamnosus, Streptococcus thermophilus, Streptococcus lactis, Streptococcus raffinolactis, Streptococcus cremoris, Bifidobacterium adolescentis, Bifidobacterium animalis, Bifidobacterium bifidum, Bifidobacterium breve, Bifidobacterium infantis, Bifidobacterium lactis, or Bifidobacterium longum species.

One or more lactic acid bacteria can be used for obtaining a fermented dairy composition according to the invention. Thus, in a preferred embodiment, a plurality of species of lactic acid bacteria comprising of Streptococcus thermophilus and Lactobacillus delbrueckii subsp. bulgaricus is used for obtaining a fermented dairy composition according to the invention.

In a further embodiment, bacteria comprising of Streptococcus thermophilus, Lactobacillus delbrueckii subsp. bulgaricus, Bifidobacterium and Lactococcus are used for obtaining a fermented dairy composition according to the invention. Accordingly in one embodiment the invention provides a fermented dairy composition comprising of Streptococcus thermophilus and Lactobacillus delbrueckii subsp. bulgaricus, which in a further embodiment may additionally comprise Bifidobacterium and Lactococcus bacteria.

In an alternative preferred embodiment, a plurality of species of lactic acid bacteria comprising of Lactococcus lactis species is used for obtaining a fermented dairy composition according to the invention. In a further embodiment, bacteria comprising of Streptococcus thermophilus, Lactobacillus delbrueckii subsp. bulgaricus, and Lactococcus lactis are used for obtaining a fermented dairy composition according to the invention. Accordingly in one embodiment the invention provides a fermented dairy composition comprising of Streptococcus thermophilus, Lactobacillus delbrueckii subsp. bulgaricus, and Lactococcus lactis.

The expressions “fermented milk” and “yogurt” have the usual meanings attributed to them and may in appropriate circumstances be used interchangeably, e.g. a fermented dairy composition comprising Lactobacillus bulgaricus, Streptococcus thermophilus and further additional bacteria (e.g. probiotic strains) may be referred to as a “fermented milk” or alternatively as “yogurt”.

Methods for the preparation of fermented milk compositions, such as yogurts or equivalents thereof, are well-known in the art. Typically a fermented milk composition is prepared by culture of heat-treated (e.g. pasteurized) skimmed and/or non-skimmed milks with suitable microorganisms to provide a reduction in pH. The selection of suitable microorganisms (e.g. thermophilic lactic acid bacteria) is within the scope of the skilled person and for the preparation of yogurt will typically include Lactobacillus bulgaricus (also referred to as Lactobacillus delbruckei subsp. bulgaricus) and Streptococcus thermophilus, optionally with additional microorganisms such as but not limited to probiotic species or other species that may provide desirable organoleptic qualities to the composition.

The fermented milk composition, in particular the fermented dairy milk composition, according to the invention, may optionally further comprise secondary ingredients added after the completion of fermentation such as fruits, vegetables, nutritive and non-nutritive sweeteners, cereals, flavours, starch, thickeners, preservatives or stabilizers. Preferably the dairy composition, in particular the fermented dairy composition, according to the invention shall comprise up to about 30% (w/w) of said secondary ingredients, e.g. up to about 10%, 15%, 20%, 25% (w/w).

Preferably the fermented milk composition, in particular the fermented dairy milk composition, comprises, comprises essentially or consists of milk that has been subjected to heat treatment at least equivalent to pasteurization, preferably said heat treatment is carried out prior to the preparation of the dairy composition or fermented dairy composition.

Preferably the invention provides a fermented milk composition, in particular a fermented dairy milk composition, more preferably a fermented milk composition that comprises above about 0.3 g per 100 g by weight free lactic acid. More preferably the invention provides a fermented milk composition comprising above about 0.7 g or 0.6 g per 100 g by weight free lactic acid.

Preferably the dairy composition according to the invention is a fermented milk composition, in particular a fermented dairy milk composition, that comprises a protein content at least equivalent to that of the milk or milks from which it is derived.

Preferably the fermented milk composition, in particular the fermented dairy milk composition, has a pH equal to or lower than 5, more preferably between about 3.5 and about 4.5.

Preferably the fermented milk composition, in particular the fermented dairy milk composition, has a viscosity lowerthan 200 mPa.s, more preferably lowerthan 100 mPa.s and most preferably lower that 60 mPa.s, at 10° C., at a shear rate of 64 s⁻¹. In one embodiment the dairy composition according to the invention is a drinkable fermented dairy composition, more preferably a fermented milk drink such as but not limited to a yogurt drink, kefir etc.. In an alternative embodiment the dairy composition according to the invention is a fermented dairy composition, more preferably a fermented milk composition that is spoonable. As used herein the term “spoonable” shall be taken to mean a solid or semi-solid that may be consumed by means of a spoon or other utensil.

Preferably also, fermented milk composition, in particular the fermented dairy milk composition, according to the invention, or the product according to the invention, may be stored at a temperature of from 1° C. to 10° C.

A single serving portion of the fermented milk composition, in particular the fermented dairy milk composition, is provided in a single serving portion preferably about 50 g, 60 g, 70 g, 75 g, 80 g, 85 g, 90 g, 95 g, 100 g, 105 g, 110 g, 115 g, 120 g, 125 g, 130 g, 135 g, 140 g, 145 g, 150 g, 200 g, 300 g or 320 g or alternatively about 1 oz, 2 oz, 3 oz, 4 oz, 5 oz, 6 oz or 12 oz by weight.

Preferably, fermented milk composition, in particular the fermented dairy milk composition, comprises at least 10⁶, more preferably at least 10⁷ and most preferably at least 10⁸ colony forming unit (CFU) each of Lactobacillus bulgaricus (also referred to as Lactobacillus delbruckei subsp. bulgaricus), Streptococcus thermophilus and/or Lc. lactis, according to the invention per gram (g) of composition according to the invention e.g. at least of 5 x 10⁶ Lactobacillus bulgaricus and 5 x 10⁶ Streptococcus thermophilus. Preferably also the composition according to the invention comprises up to about 10¹¹, more preferably at least 10¹⁰ and most preferably at least 10⁹ colony forming unit (CFU) of Lactobacillus bulgaricus (also referred to as Lactobacillus delbruckei subsp. bulgaricus), Streptococcus thermophilus and/or Lc. lactis bacteria per gram (g) of composition according to the invention.

Methods for the preparation of fermented milk compositions, such as yogurts or equivalents thereof, are well-known in the art. Typically a fermented milk composition is prepared by culture of heat-treated (e.g. pasteurized) skimmed and/or non-skimmed milks with suitable microorganisms to provide a reduction in pH. The selection of suitable microorganisms (e.g. thermophilic or mesophillic lactic acid bacteria) is within the scope of the skilled person and for the preparation of yogurt will typically include Lactobacillus bulgaricus (also referred to as Lactobacillus delbruckei subsp. bulgaricus) and Streptococcus thermophilus, optionally with additional microorganisms such as but not limited to probiotic species and/or other species that may provide desirable organoleptic qualities to the composition. Fermented milk compositions may be either or set or stirred subsequent to fermentation.

The invention will be further illustrated by the following non-limiting Figures and Example.

### DESCRIPTION OF THE FIGURES

FIG. 1 provides the levels of HICA, HIVA & HMVA between unfermented milk and fermented milk samples as analyzed in Example 1.

### EXAMPLES

### Example 1: Identification and Quantification of Target Metabolites

Untargeted metabolome profiling of lyophilized yogurt and milk was conducted through mass spectrometry using the Metabolon HD4 global metabolomics platform. A total of 317 metabolites were measured and 195 of them were differently abundant between lyophilized yogurt and milk (q-value ≤0.05).

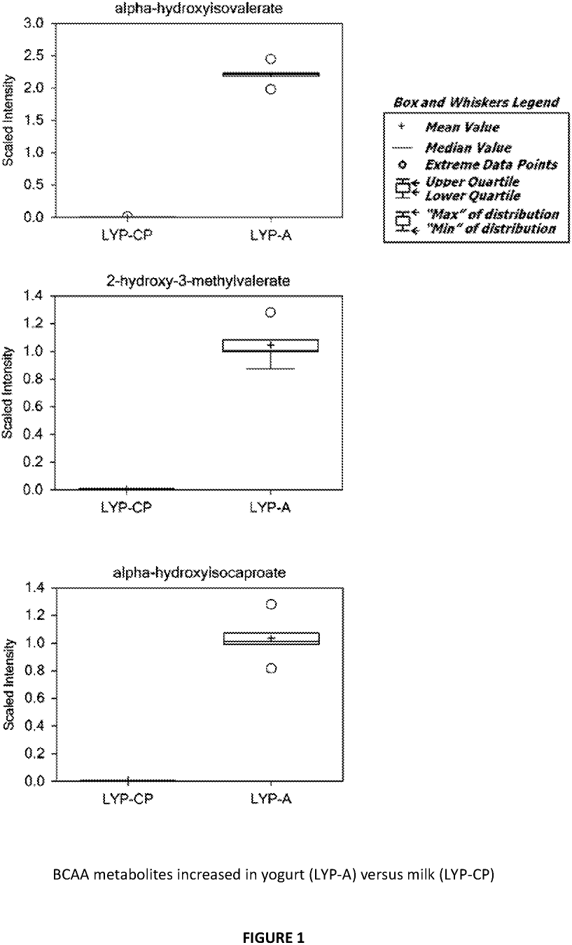

Three of these 195 metabolites matched to identified hepatic metabolites: alpha-hydroxyisocaproate (HICA), alpha-hydroxyisovalerate (HIVA) and 2-hydroxy-3-methylvalerate (HMVA) (FIG. 1). These metabolites fell in leucine, isoleucine and valine metabolism pathway and it was surprisingly observed that HICA, HIVA and HMVA, collectively branched chain hydroxy acids (h-BCAA), were present in lyophilized yogurt but absent in lyophilized milk.

h-BCAA levels in the lyophilized yogurt and milk were quantified using NMR analysis. It was observed that HMVA metabolite was detected under two diastereomeric forms (HMVA-1 and HMVA-2) and that HICA and HIVA were over-represented compared to HMVA diastereomers. The h-BCAA levels in lyophilized milk were below the limit of detection (1.2 µM for HICA and HIVA, 2.5 µM for HMVA).

Without wishing to be bound by theory the Inventor notes that these may be associated with dietary intake, insulin secretion, liver triglyceride, glucose metabolism & protein.

### Example 2: Quantification of Fermentation Metabolites in Milk, Fermented Milk Products And Plant-Based Alternatives

Quantification of HICA, HIVA & HMVA was carried out by NMR on the following products (5 samples of each product was tested):
3 dairy milk plain yogurts (i.e. no added fruit or flavours)
2 dairy milk “probiotic” yogurt type products
2 alternative fermented dairy milk preparations (“Fromage Blanc” & Skyr)
2 dairy-free plant-based
Cow milk (unfermented)

Further details and results of sample analysis (mean values) are provided in Table 1.

None of BCAA metabolites were detected in milk, and were present at greatly reduced levels in the dairy-free alternatives. Thus the presence of HICA, HIVA & HMVA are taken to likely be the result of the dairy milk fermentation by means of lactic acid bacteria.

Interestingly, levels of h-BCAA differed by five-fold between tested products that had a similar energy and macronutrient composition. Furthermore, protein quantity only in yogurt or fermented milk products did not explain the differences in h-BCAA levels. The highest concentration of h-BCAA was detected in “Fromage Blanc” that are known to be fermented by mesophilic Lc. Lactis cultures. These findings indicate that h-BCAA are generated upon milk fermentation as a function of the starter culture strains, protein content and technological process.

TABLE 1

| | | | | | | | | | | | | | | |
|---|---|---|---|---|---|---|---|---|---|---|---|---|---|---|
| \Product | Milk | Milk | Milk | Milk | Milk | “Fromage Blanc” plain | Plain style yogurt (1) | Plain style yogurt (2) | Plain style bifidobac teria yogurt (2) | Plain L. casei yogurt-type drink (2) | “Skyr” plain | Plain style yogurt (3) | Plant-based dairy-free soy-coconut yogurt alternative | Plant-based dairy-free soy yogurt alternative |
| HICA (mg/l) | 0 | 0 | 0 | 0 | 0 | 30.7 | 12.0 | 6.9 | 6.9 | 4.8 | 3.1 | 2.8 | 0.4 | 0.6 |
| HIVA (mg/l) | 0 | 0 | 0 | 0 | 0 | 35.2 | 12.8 | 3.2 | 7.5 | 4.9 | 3.5 | 1.5 | 0.2 | 0.1 |
| HMVA (mg/l) | 0 | 0 | 0 | 0 | 0 | 6.8 | 6.0 | 3.6 | 4.2 | 3.1 | 4.8 | 2.4 | 1.4 | 1.7 |
| Hydroxy-BCAAs (mg/l) | 0 | 0 | 0 | 0 | 0 | 72.6 | 30.8 | 13.6 | 18.6 | 12.9 | 11.3 | 6.6 | 2.0 | 2.4 |
| Hydroxy-BCAAs mg/ g protein | | | | | | 1.05 | 0.72 | 0.36 | 0.55 | 0.43 | 0.11 | 0.15 | 0.05 | 0.06 |
| Energy (kcal/ 100 g) | 33 | 45 | 64 | 64 | 64 | 72 | 72 | 45 | 62 | 73 | 57 | 72 | 55 | 43 |
| Fat(g/100 g) | 0.1 | 1.5 | 3.6 | 3.6 | 3.6 | 3.0 | 3.5 | 1.0 | 3.4 | 1.6 | 0.2 | 3.3 | 3.0 | 2.3 |
| Sat. Fat (g/100 g) | 0.0 | 1.0 | 2.2 | 2.4 | 2.4 | 2.1 | 2.4 | 0.6 | 2.4 | 1.0 | 0.1 | 2.3 | 1.1 | 0.4 |
| Carbohydrate (g/100 g) | 4.8 | 4.8 | 4.8 | 4.8 | 4.8 | 4.4 | 5.7 | 5.1 | 4.4 | 10.8 | 3.9 | 5.7 | 2.3 | 0.0 |
| Sugar(g/100 g) | 4.8 | 4.8 | 4.8 | 4.8 | 4.8 | 4.4 | 5.7 | 5.1 | 4.4 | 10.8 | 3.9 | 5.1 | 2.1 | 0.0 |
| Protein (g/100 g) | 3.3 | 3.2 | 3.2 | 3.2 | 3.2 | 6.9 | 4.3 | 3.8 | 3.4 | 3.0 | 10.0 | 4.4 | 3.9 | 4.0 |
| Salt (g/100 g) | 0.10 | 0.11 | 0.11 | 0.13 | 0.10 | 0.11 | 0.14 | 0.14 | 0.12 | 0.1 | 0.09 | 0.13 | 0.32 | 0.25 |
| Calcium (mg/100 g) | 120 | 120 | 120 | - | 120 | 130 | 149 | 136 | 119 | 120 | 110 | 120 | 120 | 120 |
| Vitamin D (µg) | - | 0.8 | 0.75 | - | - | 1.25 | - | - | | 0.21 | | 0.75 | 0.75 | 0.75 |
| Vitamin B12 (µg) | | | | | | | | | | 0.75 | | | 0.38 | 0.38 |
| Fibre (g) | | | | | | | | | | | | | 0.8 | 1.0 |
| Culture species | | | | | | | | | | | | | | |
| S. thermophilus | | | | | | | x | x | x | x | x | | x | x |
| L. bulgaricus | | | | | | | x | x | x | x | x | | x | x |
| B. animalis lactis | | | | | | | | | x | | | | | |
| L. rhamnosus | | | | | | | | | | | | | | |
| Lactococus lactis lactis | | | | | | x | | | x | | | | | |
| Lactococus lactis cremoris | | | | | | x | | | | | | | | |
| L. casei | | | | | | | | | | x | | | | |

1. (canceled)

2. A method for dietary supplementation of branched-chain amino acid (BCAA). metabolites, in a subject comprising administering a fermented milk composition comprising said BCAA metabolites to a subject in need thereof.

3. The method according to claim 2, wherein said BCAA metabolites are hydroxy branched-chain amino acid (h-BCAA) metabolites.

4. The method according to claim 1, wherein said fermented milk composition is fermented by means of lactic acid bacteria.

5. The method according to claim 4, wherein said lactic acid bacteria is selected from the group consisting of S. thermophilus, L. bulgaricus, Lc. lactis, Lc. cremoris and combinations thereof.

6. The method according to claim 3, wherein said h-BCAA is a lactic acid bacteria metabolite of milk fermentation.

7. The method according to claim 2, wherein said fermented milk composition comprises 20% w/w or less fermented plant-based matter.

8. The method according to claim 2, wherein said fermented milk composition comprises at least about 5.00 mg/L h-BCAA.

9. The method according to claim 2, wherein said fermented milk composition comprises at least about 2.50 mg/L alpha-hydroxyisocaproic acid (HICA).

10. The method according to claim 2, wherein said fermented milk composition comprises at least about 1.00 mg/L alpha-hydroxyisovaleric acid (HIVA).

11. The method according to claim 2, wherein said fermented milk composition comprises at least about 2.00 mg/L 2-hydroxy-3-methylvaleric acid (HMVA).

12. The method according to claim 2, wherein said milk is dairy milk.

13. The method according to claim 3, wherein said h-BCAA metabolites comprise HICA, HIVA, HMVA, or combinations thereof.
